(19) United States
(12) Patent Application Publication
(10) Pub. No.: US 2024/0020105 A1
(43) Pub. Date: Jan. 18, 2024

(54) TARGETED SOFTWARE AND HARDWARE UPDATES FOR USER EQUIPMENT BASED ON SPECIFIC USER PROFILES RELATED TO THEIR USAGE

(71) Applicant: AT&T Intellectual Property I, L.P., Atlanta, GA (US)

(72) Inventors: Rashmi Palamadai, Naperville, IL (US); Yupeng Jia, Austin, TX (US)

(21) Appl. No.: 17/812,031

(22) Filed: Jul. 12, 2022

(51) Int. Cl. G06F 8/65; H04L 67/306; H04L 41/0893; H04L 41/0823

(52) U.S. Cl. CPC G06F 8/65; H04L 67/306; H04L 41/0893; H04L 41/0823

(57) ABSTRACT

Techniques are described for providing targeted software and hardware updates for user equipment (UE) based on specific user profiles related to their usage thereof. In one example embodiment, a system includes a processor and a memory that stores executable instructions that, when executed by the processor, facilitate performance of operations. These operations include clustering user identities into different user groups based on different goals determined to be applicable to the user identities related to usage of user equipment respectively associated with the user identities. The operations further include determining different equipment updates for the user equipment tailored to the different user groups, and provisioning the different equipment updates to the user equipment corresponding to the different user groups.

### TECHNICAL FIELD

This disclosure relates to computer-implemented systems and methods that facilitate providing targeted software and hardware updates for user equipment (UE) based on specific user profiles related to their usage.

### DESCRIPTION OF THE DRAWINGS

FIG. 1 illustrates an architecture diagram of an example, non-limiting system that facilitates providing targeted software and hardware updates for user equipment (UE) based on specific user profiles related to their usage thereof, in accordance with one or more embodiments of the disclosed subject matter.

FIG. 2 illustrates an example, non-limiting computing device that facilitates providing targeted software and hardware updates for UE based on specific user profiles related to their usage thereof, in accordance with one or more embodiments of the disclosed subject matter.

FIG. 3 illustrates another example, non-limiting computing device that facilitates providing targeted software and hardware updates for UE based on specific user profiles related to their usage thereof, in accordance with one or more embodiments of the disclosed subject matter.

FIG. 4 illustrates another example, non-limiting computing device that facilitates providing targeted software and hardware updates for UE based on specific user profiles related their usage thereof, in accordance with one or more embodiments of the disclosed subject matter.

FIG. 5 illustrates a block diagram of an example, non-limiting computer implemented method for providing targeted software and hardware updates for UE based on specific user profiles related to their usage thereof, in accordance with one or more embodiments of the disclosed subject matter.

FIG. 6 illustrates a block diagram of another example, non-limiting computer implemented method for providing targeted software and hardware updates for UE based on specific user profiles related to their usage thereof, in accordance with one or more embodiments of the disclosed subject matter.

FIG. 7 illustrates a block diagram of another example, non-limiting computer implemented method for providing targeted software and hardware updates for UE based on specific user profiles related to their usage thereof, in accordance with one or more embodiments of the disclosed subject matter.

FIG. 8 illustrates a block diagram of an example, non-limiting operating environment in which one or more embodiments described herein can be facilitated.

FIG. 9 illustrates a block diagram of another example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background section, Summary section or in the Detailed Description section.

The disclosed subject matter is directed to providing targeted software and hardware updates for UE based on specific user profiles related to their usage thereof. Typically, telecommunication service providers provide UE, (i.e., user devices such as mobile phones/smartphones, smartwatches, smart home devices, and a wide range of other types of communication devices) subscribed to their telecommunications network software updates as mass updates to all UE in a passive fashion (e.g., without consideration of device needs and context). The disclosed subject matter provides a much more highly targeted approach to provision of software updates (e.g., firmware, operating system updates, application and program updates, etc.) to UE based on needs of the equipment user pertaining to their goals and activities for which they use and/or intend to use their device. The disclosed techniques are also extended to providing targeted hardware updates (e.g., device add-ons, new devices, device hardware accessories, etc.) to UE based on such needs of the equipment user.

In various embodiments, the telecommunication service provider has a record of hardware and software on all customer devices. The provider can further maintain user profile information for respective device users identifying their respective devices and comprising information regarding their device usage goals/needs. Based on the variety of hardware and software updates available on the network and a particular device usage goal (or need, demand, intention, etc.), such as gaming, education, content creation, and so on, the telecommunication service provider (e.g., or another entity associated therewith) can identify a target group of devices to provide software/hardware updates targeted to the respective groups' device usage goals/needs. In this regard, the provider can tailor different updates to different user groups as opposed to providing all UE the same routine software/hardware updates.

In one or more embodiments, the user goals/needs and corresponding targeted updates tailored thereto can be intelligently determined (e.g., using machine learning and artificial intelligence) and proactively provided and/or recommended to facilitate the respective current and forecasted users' device usage goals/needs. The provider can further track changes in respective users' device usage goals/needs over time, update their profile information accordingly and suggest new updates based on changes in their goals/needs. For example, the provider can detect when a user has progressed from a basic gamer to a more professional gamer and suggest hardware and/or software updates that can enhance their gaming experience as a professional gamer. In some implementations, the updates can be based on queries on specific groups and prioritized to respective users in the group as a function of relative need/demand and other ordering criteria. For example, in some embodiments, certain users can serve as update testers (e.g., alpha/beta testers), and/or facilitate promoting new updates to other relevant users in their corresponding user group. For example, social media “influencers” can receive prioritized updates in exchange for promotion thereof on their social media channels. The disclosed techniques further provide a negotiation process wherein the provider and respective users can negotiate provision of relevant updates, exchange feedback regarding device update needs/goals, and negotiate group-based rates for group targeted updates.

The provider can further tailor timing of provision of software and/or hardware updates targeted for a specific user group based on a timing determined to be relevant to the group. For instance, assuming a user group corresponds to gamers that were identified based in part on registration for a particular upcoming gaming event, the provider can send equipment updates to the group that can enhance their gaming experience at or near a time coinciding with the event.

To facilitate this end, in one or more embodiments, a system is provided comprising a processor, and a memory that stores executable instructions that, when executed by the processor, facilitate performance of operations. These operations can comprise clustering user identities (i.e., device users represented by a name/user profile and associated with one or more user devices) into different user groups based on different goals determined to be applicable to the user identities related to usage of user equipment respectively associated with the user identities. The clustering can also be based on additional criterion such as but not limited to, social media status, user interests, user activities, existing device hardware/software (e.g., clustering users having similar device hardware/software), and various other criteria. These operations further comprise determining different equipment updates for the user equipment tailored to the different user groups and provisioning the different equipment updates to the user equipment corresponding to the different user groups.

In some implementations, the different equipment updates comprise different software updates, and wherein the provisioning comprises sending the different software updates to the user equipment corresponding to the different groups based on and/or in response to determining the corresponding updates. In other implementations, the different equipment updates comprise different hardware updates, and wherein the provisioning comprises sending the different hardware updates to respective physical locations associated with the user identities corresponding to the different groups based on and/or in response to determining the corresponding updates.

The operations can further comprise identifying a group of the different user groups associated with a goal of the different goals that is able to be facilitated by an equipment update related to respective user equipment of the group, and notifying the respective user equipment of the group regarding the equipment update based on the identifying. For example, the notifying can comprise sending, to the respective user equipment of the group, notification information regarding the equipment update. In various implementations in which the update comprises a software update, the operations can comprises sending the software update to the respective user equipment of the group based on and/or in response to identifying the group. The operations can further comprise determining a hierarchical ranking of respective user identities included in the group based one or more criteria (e.g., on a status of the respective user identities, rate plans associated with the respective users, priority levels of respective users, etc.) and wherein the sending comprises sending the software update to the respective user equipment in an order determined according to the hierarchical ranking.

The operations can further comprise learning the different goals of the user identities using machine learning based on analysis of tracked information for the user identities, wherein the tracked information comprises historical usage information related to historical usage of the user equipment by the user identities. In some implementations, the tracked information can also include registration information regarding registration of the user identities for events, and social media activity.

In some embodiments, the non-limiting term user equipment (UE), communication device (CD), (or a similar term) is used. It can refer to any type of wired or wireless device that can communicate with a network node in a wired or wireless communication system and/or a radio network node in a cellular or mobile communication system. The terms user equipment (UE) and communication device (CD) are used herein interchangeably. Examples of communication devices (CDs) can include, but are not limited to, a computer (e.g., a desktop computer, a laptop computer, laptop embedded equipment (LEE), laptop mounted equipment (LME), or other type of computer), a mobile terminal, a cellular and/or smart phone, a tablet or pad (e.g., an electronic tablet or pad), an electronic notebook, an electronic gaming device, a virtual reality (VR) device, an augmented reality (AR) device, an extended reality (XR) device, electronic eyeglasses, headwear, or bodywear (e.g., electronic or smart eyeglasses, headwear (e.g., an AR, VR or XR headset), or bodywear (e.g., electronic or smart watch) having wireless communication functionality), a set-top box, an IP television (IPTV), a device to device (D2D) UE, a machine type UE or a UE capable of machine to machine (M2M) communication, a Personal Digital Assistant (PDA), a smart meter (e.g., a smart utility meter), a target device, devices and/or sensors that can monitor or sense conditions (e.g., health-related devices or sensors, such as heart monitors, blood pressure monitors, blood sugar monitors, health emergency detection and/or notification devices, or other type of device or sensor), a broadband communication device (e.g., a wireless, mobile, and/or residential broadband communication device, transceiver, gateway, and/or router), a dongle (e.g., a Universal Serial Bus (USB) dongle), a music or media player, speakers (e.g., powered speakers having wireless communication functionality), an appliance (e.g., a toaster, a coffee maker, a refrigerator, or an oven, or other type of appliance having wireless communication functionality), a device associated or integrated with a vehicle (e.g., automobile, airplane, bus, train, or ship, or other type of vehicle), a virtual assistant (VA) device, a drone, a home or building automation device (e.g., security device, climate control device, lighting control device, or other type of home or building automation device), an industrial or manufacturing related device, a farming or livestock ranch related device, and/or any other type of communication devices (e.g., other types of IoTs).

In some embodiments, the non-limiting term radio network node or simply network node, radio network device or simply network device and network equipment are used herein. These terms may be used interchangeably, and refer to any type of network node that can serve a UE and/or be connected to other network node or network element or any radio node from where user equipment receives signal. Examples of radio network nodes are Node B, base station (BS), multi-standard radio (MSR) node such as MSR BS, gNodeB, eNode B, access point (AP) devices, network controller, radio network controller (RNC), base station controller (BSC), relay, donor node controlling relay, base transceiver station (BTS), transmission points, transmission nodes, radio resource unit (RRU), remote radio head (RRH), nodes in distributed antenna system (DAS), etc.

The term equipment update as used herein refers to referrers to any type of hardware or software component update related to user equipment. Reference to a software update can include a change to an existing software component associated with a UE and/or a new software component compatible with the UE. Some example software updates can include but are not limited to, new or updated firmware, new or updated applications, new or update programs, new or updated programing logic, and new or updated operating system logic. Reference to a hardware update can include a change to an existing hardware component associated with a UE and/or a new hardware component or device that can be used with an existing UE, replace an existing UE and/or compliment a functionality of an existing UE. Some example hardware updates can include but are not limited to, device add-ons, device accessories, new hardware components adapted to integrate with an existing UE, and new UE with different hardware relative to a previous UE.

The term device accessory or simply accessory as used herein can refer to any device that adapted to be used in conjunction with a communication device. An accessory can include an electronic device or mechanical apparatus configured to communicatively couple/connect with a communication device via a wired and/or wireless connection as well as devices/apparatuses without communication capabilities (e.g., providing a mechanical function, a decorative function, a protective function, and so on).

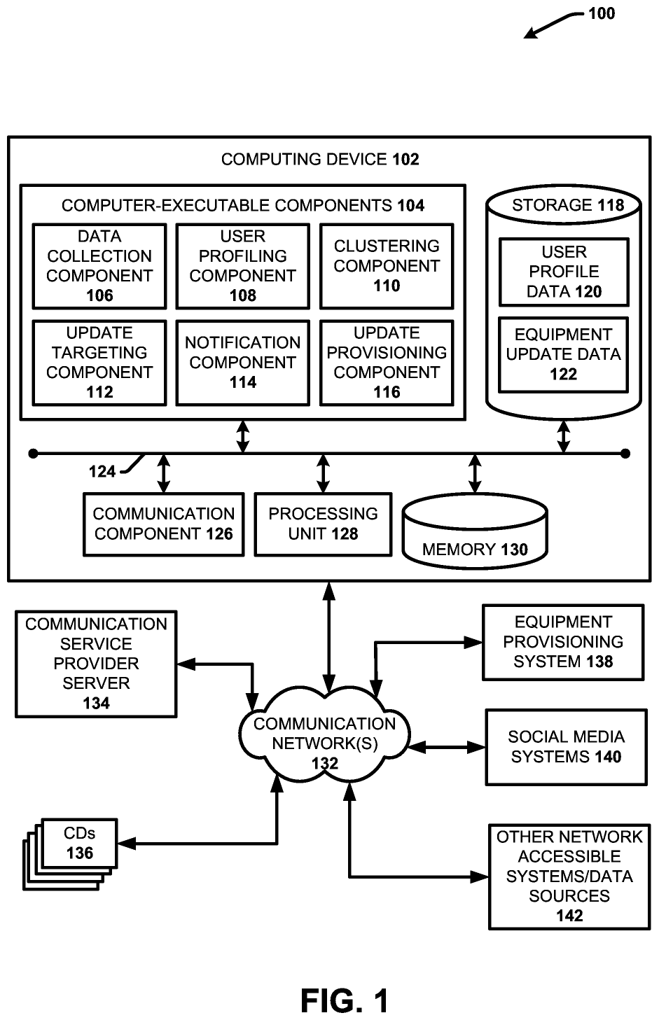

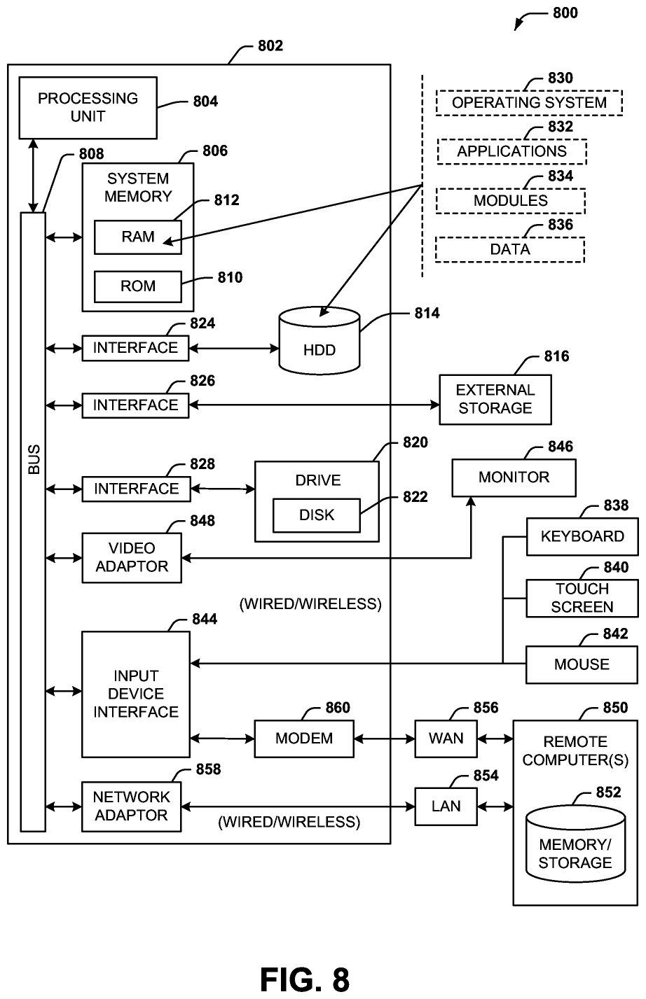

Embodiments of systems and devices described herein can include one or more machine-executable components or instructions embodied within one or more machines (e.g., embodied in one or more computer-readable storage media associated with one or more machines). Such components, when executed by the one or more machines (e.g., processors, computers, computing devices, virtual machines, etc.) can cause the one or more machines to perform the operations described. These computer/machine executable components or instructions (and other described herein) can be stored in memory associated with the one or more machines. The memory can further be operatively coupled to at least one processor, such that the components can be executed by the at least one processor to perform the operations described. Examples of said and memory and processor as well as other suitable computer or computing-based elements, can be found with reference to FIG. 8 (e.g., processing unit 804 and system memory 806 respectively), and can be used in connection with implementing one or more of the systems or components shown and described in connection with FIG. 1, or other figures disclosed herein.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Turning now to the drawings, FIG. 1 illustrates an architecture diagram of an example, non-limiting system 100 that facilitates providing targeted software and hardware updates for UE based on specific user profiles related to their usage thereof, in accordance with one or more embodiments of the disclosed subject matter. System 100 includes a variety of devices, systems and data sources that may be interconnected either directly and/or via one or more communication networks 132. These devices, systems and data sources include computing device 102, communication service provider server 134, a plurality of communication devices (CDs) 136, equipment provisioning system 138, one or more social media systems 140, and various other network accessible systems/data sources 142.

The CDs 136 correspond to communication devices (also referred to as UEs) that can communicate with one another and/or other devices/systems via the one or more communication networks 132. In this regard, the one or more communication networks 132 can comprise but are not limited to, wired and wireless networks, including, but not limited to, a cellular or mobile network, a wide area network (WAN) (e.g., the Internet), a local area network (LAN), and combinations thereof. Such networks 132 can include Universal Mobile Telecommunications System (UMTS) networks, Long-Term Evolution (LTE) networks, Third Generation Partnership Project (3GPP) networks (or 3G), Fourth Generation (4G) networks, Fifth Generation (5G) networks, Sixth Generation (6G) networks (and beyond), Code Division Multiple Access (CDMA) networks, Wi-Fi networks, Worldwide Interoperability for Microwave Access (WiMAX) networks, General Packet Radio Service (GPRS) networks, Enhanced GPRS, Ultra Mobile Broadband (UMB), High Speed Packet Access (HSPA), Evolved High Speed Packet Access (HSPA+) networks, High-Speed Downlink Packet Access (HSDPA) networks, High-Speed Uplink Packet Access (HSUPA) networks, Zigbee networks, or another IEEE 802.XX technology networks. Additionally, substantially all aspects disclosed herein can be exploited in legacy telecommunication technologies. Further, the various aspects can be utilized with any Radio Access Technology (RAT) or multi-RAT system where the mobile device operates using multiple carriers (e.g., LTE Frequency Division Duplexing (FDD)/Time-Division Duplexing (TDD), Wideband Code Division Multiplexing Access (WCMDA)/HSPA, Global System for Mobile Communications (GSM)/GSM EDGE Radio Access Network (GERAN), Wi Fi, Wireless Local Area Network (WLAN), WiMax, CDMA2000, and so on), and satellite networks.

The CDs 136 can include a wide range of different types of devices. For example, the CDs 136 can include, but are not limited to, a computer (e.g., a desktop computer, a laptop computer, a LEE, a LME, or other type of computer), a mobile terminal, a cellular and/or smart phone, a tablet or pad (e.g., an electronic tablet or pad), an electronic notebook, an electronic gaming device, electronic eyeglasses (e.g., an electronic or smart eyeglasses), headwear (e.g., an AR or VR headset), bodywear (e.g., an electronic or smart watch having wireless communication functionality), a set-top box, an IPTV, a D2D type UE, a machine type UE or a UE capable of M2M communication, a PDA, a smart meter (e.g., a smart utility meter), a target device, devices and/or sensors that can monitor or sense conditions (e.g., health-related devices or sensors, such as heart monitors, blood pressure monitors, blood sugar monitors, health emergency detection and/or notification devices, or other type of device or sensor), a broadband communication device (e.g., a wireless, mobile, and/or residential broadband communication device, transceiver, gateway, and/or router), a dongle (e.g., a USB dongle), a music or media player, speakers (e.g., powered speakers having wireless communication functionality), an appliance (e.g., a toaster, a coffee maker, a refrigerator, or an oven, or other type of appliance having wireless communication functionality), a device associated or integrated with a vehicle (e.g., automobile, airplane, bus, train, or ship, or other type of vehicle), a VA device, a drone, a home or building automation device (e.g., security device, climate control device, lighting control device, or other type of home or building automation device), an industrial or manufacturing related device, a farming or livestock ranch related device, and/or any other type of communication devices (e.g., other types of IoTs).

In one or more embodiments, the CDs 136 correspond to user devices respectively associated with different users. An individual user can be associated with a single CD (e.g., a personal smartphone) or a group of CDs 136 (e.g., a smartphone, a smart watch, an AR device, smart home devices, etc.). In some implementations, a group of users (e.g., including two or more) may be associated with a single CD (e.g., a shared family device such as an IPTV) or a group of CDs (e.g., a group of shared devices). It should also be appreciated that a few CDs 136 are illustrated or brevity and that in practice, the number of CDs associated with system 100 can include hundreds, thousands, millions, billions, etc., of CDs depending on size the geographic coverage area of the one or more communication networks 132.

In various embodiments, the one or more communication networks 132 can include or correspond to a communication network serviced by one or more communication network providers. For example, in some implementations, the communication network provider may correspond to a telecommunications service provider/carrier that provides a wide range of different types of telecommunication services to different types of CDs 136 via one or more communication networks (e.g., of communication networks 132) and sub-networks comprised of network equipment/resources owned/operated by the telecommunication service provider. The types of services can vary depending on the network capabilities and communication technologies supported by the communication network (e.g., cellular 3G, 4G, 5G, Wi-Fi, satellite, etc.) and the features and functionalities of the respective CDs 136. For example, as applied to advanced communication network providers providing New Radio/5G communication networks and beyond, the types services can relate to, for example, video streaming, video calls, video content, audio streaming, audio calls, audio content, electronic gaming, education, text messaging, multimedia messaging, emails, website content, medical information (e.g., medical information from wireless medical devices associated with users), utility information (e.g., utility information from smart meters), emergency-related information, military-related information, law enforcement-related information, fire response services-related information, disaster response services-related information, and/or other desired types of information, content, or activities.

With these embodiments, the communication network provider can control provision of communication services to respective CDs 136 via the communication network in accordance with established communication service agreements (e.g., customer/user subscription agreements/plans) associated with the respective CDs 136 and their users. For example, the communication service provider can maintain customer/subscriber account information for all subscribed users that uniquely identifies each subscriber of the network (e.g., via username/account information) and uniquely identifies their associated CD or CDs (e.g., via unique device identifiers) authorized to employ the network. In accordance with system 100, the communication service provider server 134 can correspond to a server device associated with the communication service provider that maintains or otherwise provides access to such subscriber information for the communication service provider. Additionally, or alternatively, the communication service provider server 134 can correspond to one or more server devices associated with the communication service provider network core that provides various network core functionalities. In some implementations of these embodiments, the computing device 102 can correspond to the communication service provider server 134 (or vice versa). In this regard, the computing device 102 can correspond to an internal network device owned/operated/controlled by the communication service provider. In other embodiments, the computing device 102 can be associated with a third-party entity external to the communication service provider.

The computing device 102 can perform various operations relating to determining and providing targeted equipment (e.g., software and/or hardware) updates for the CDs 136 based on specific user profiles (e.g., provided in user profile data 120) related to their usage thereof. In one or more embodiments, these operations can be defined by computer-executable components 104 associated with the computing device 102. In this regard, the computing device 102 can include computer-executable components 104, storage 118, communication component 126, processing unit 128, memory 130 and device bus 124.

The computer-executable components 104 can include or correspond to readable, writable, and/or executable components and/or instructions that, that when executed by at least processor, can facilitate execution of the various functions described defined by the executable component(s) and/or instruction(s). These computer-executable components 104 can include data collection component 106, user profiling component 108, clustering component 110, update targeting component 112, notification component 114, update provisioning component 116, and other computer-executable components 104 that can be used to implement aspects of system 100, as described herein. Each of these components are described in detail, with one or more embodiments described below. These computer-executable components 104 can be stored in memory associated with the one or more machines. The memory can further be operatively coupled to at least one processor, such that the components can be executed by the at least one processor to perform the operations described.

For example, in some embodiments, the computer-executable components 104 can be stored in memory 130 and/or storage 118 of the computing device 102 which can be coupled to processing unit 128 for execution thereof. In some embodiments, memory 130 can comprise volatile memory (e.g., random access memory (RAM), static RAM (SRAM), dynamic RAM (DRAM), etc.) that can employ one or more memory architectures. In some embodiments, storage 118 can comprise non-volatile memory (e.g., read only memory (ROM), programmable ROM (PROM), electrically programmable ROM (EPROM), electrically erasable programmable ROM (EEPROM), etc.) that can employ one or more storage architectures. Examples of said and memory 120, storage 118 and processing unit 128 as well as other suitable computer or computing-based elements, can be found with reference to FIG. 8, and can be used in connection with implementing one or more aspects of system 100 described in connection with FIG. 1 or other figures disclosed herein.

The communication component 118 can include or correspond to communication hardware and/or software that provides for communicating information/data between (e.g., to and from) the computing device 102 and various external devices/systems and/or data sources of system 100 (e.g., the communication service provider server 134, the respective UE 136, equipment provisioning system 138, social medial systems 140, and other network accessible systems/data sources 142) using essentially any form of wired or wireless communication technology. For example, in accordance with the embodiment shown, the computing device 102 can be communicatively coupled to various external devices/systems and/or data sources of system 100 via one or more communication networks 132 and the communication component 126 can be configured to communicate using any of the corresponding wireless and/or wired communication technology of such networks.

As noted above, the computing device 102 can perform various operations defined by the computer-executable components 104 relating to determining and providing targeted equipment (e.g., software and/or hardware) updates for the CDs 136 based on specific user profiles (e.g., provided in user profile data 120) related to their usage thereof. The operations of these computer-executable components 104 are now described in greater detail.

The data collection component 106 can perform data collection operations pertaining to collecting relevant data from external devices/system/data sources of system 100 (e.g., communication service provider server 134, CDs 136, equipment provisioning system 138, social media systems 140 and other network accessible systems/data sources 142) that can facilitate determining and providing targeted equipment updates for the CDs 136. In various embodiments, any data collected (e.g., accessed and retrieved) by the data collection component 106 from external devices/system/data sources of system 100 can be stored in memory 130 and/or storage 118.

The user profiling component 108 can generate and/or update user profile data 120 for respective users of the CDs 136 (e.g., based on relevant data collected by the data collection component 106). In various embodiment, the user profile data 120 can be stored in storage 118 or another accessible memory accessible to the computing device 102. The user profile data 120 can include information that uniquely identifies different users (e.g., user “user identities” via a unique name, username, account name/number, etc.) and their associated CD or CDs (e.g., via unique device identifiers). The user profile data 120 can further include equipment information for each user's CD (or CDs) that defines or indicates the current hardware and software components of the CD, and the corresponding features and functionalities thereof. For example, the user profile data for a particular user can identify the current hardware associated with the user's CD (e.g., current device type, make, model, etc.) as well as the current software associated with the user's CD (e.g., firmware, applications, logic, programs, operating system, etc.). In various embodiments in which the one or more communication networks 132 include a communication network associated with a particular carrier/provider, this user profile data (and any other user profile information described herein) may be collected by the data collection component 106 as associated in customer/subscriber account information (e.g., provided by the communication service provider server 134) for the respective subscribed users of the particular carrier/provider (e.g., the subscriber information can provide a record of current hardware and software on all customer devices). With these embodiments, the user profile data 120 for each user (i.e., each customer/subscriber) can also include other relevant information associated with the subscriber's account, including information regarding their rate plan, service level agreement (SLA) parameters, device history (e.g., regarding past devices used by the subscriber, duration of use, etc.). In some embodiments, the user profile data 120 can also include information identifying past and current device accessories associated with each user and/or their CD or CDs (e.g., auxiliary IoT devices, headphones, devices cases, screen protectors, etc.).

In addition to providing an understanding of the current hardware and software capabilities/features associated with different subscribers' CDs 136, the user profile data 120 can further include information for the respective users identifying or indicating their goals (or demands, needs, intentions, or the like) related to usage of their respective CDs. Such user goals (or demands, needs, intentions, or the like) are specific to each user and can refer to any information that defines or indicates a purpose for which the user is currently using and/or expects to use their particular CD or group of CDs. In some embodiments, the user goals can include a plurality of goals defined in accordance with a goal priority hierarchy for the user. For example, the user goal information can include information that identifies or indicates a primary, secondary, tertiary and so on goal related to their purposes for which the user is currently using and/or expects to use their particular CD or group of CDs.

For instance, some example goals could include, but are not limited to: gaming, education, work, social media posting, content creation, video production, photography, audio production, travel/navigation, artificial intelligence (AI) personal assistance, live streaming, web-surfing, voice/video calling, text messaging, email, and so on. These goals can vary for different types of CD and groups of CDs (e.g., goals associated with usage of smart home electronics will vary relative to those associated with usage of a mobile phone) and for different users based on their individual preferences, hobbies, activities, interests, skill level (e.g., professional gamer verses a beginner gamer), demographics (e.g., age, location). In some implementations, information describing the users' individual preferences, hobbies, activities, interests, skill level, etc., relative to a particular goal/activity and demographics can also be associated with their user profile data 120. The level of specificity or granularity of the user goals (or demands, needs, intentions, or the like) can vary. For example, many types of goals may be further broken down into sub-categorical goals based on level of skill level/experience, or another subtype in accordance with a hierarchical break down structure (i.e., a tree structures) as applicable to different goal categorizations.

In some embodiments, the user profile data 120 can additionally or alternatively include information identifying on indicating a user's role or title that is related to a particular goal or purpose for which the user is currently using and/or expects to use their particular CD or group of CDs. For example, such role or title information can refer to a job/work title, a skill level (e.g., beginner, intermediate, advanced, professional, amateur, etc.), grade level (e.g., as applied to education or a similar activity), or status level. In some implementations, the user profile data 120 can particularly include user status information that pertains to a social media status level indicative of a level of popularity or influence the user has on others. For example, the role of a user as an “influencer” in the social media domain can be based on the number of friends/followers/likes and other social media activity metrics provided/determined by the user's activity on one or more social media systems 140. Information identifying user's classified as social media influencers (and their level of “influence” or popularity) can also be associated with their user profile data 120. Similarly, information identifying or indicating users considered celebrities may also be associated with their profile data.

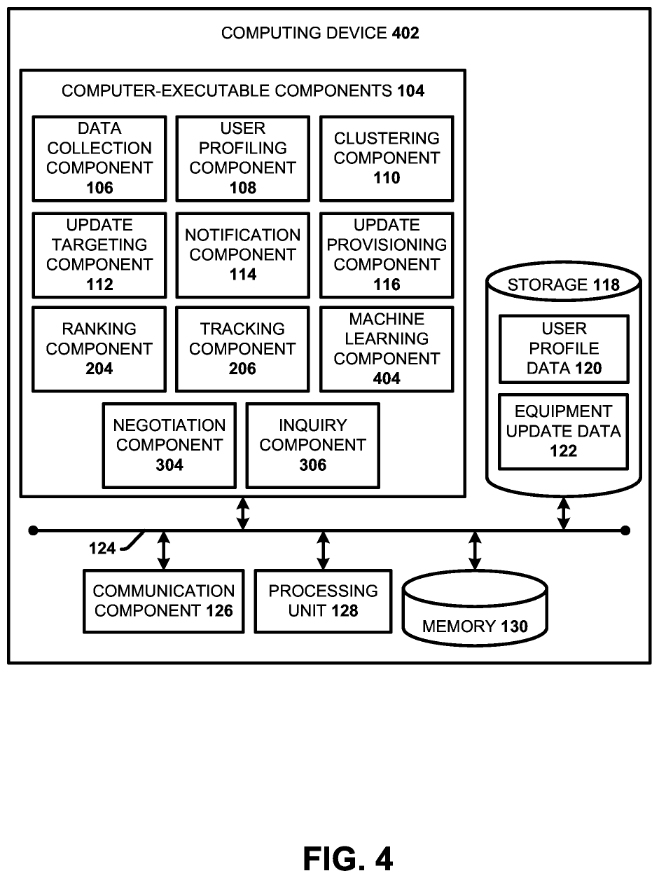

In some embodiments, the user goal information and/or information describing a user's activities, interest, preferences, hobbies, skill level, etc., role/title and related information can be expressly provided by respective users (e.g., via their respective CDs 136). For example, users can declare and provide information describing their goals (or demands, needs, intentions), activities, interests, preferences, hobbies, skill level, etc., in association with carrier/provider subscription/registration, device purchase, CD set-up, in response to a provide/carrier inquiry, or in another manner. Additionally, or alternatively, system 100 can employ principles of artificial intelligence (AI) and machine learning (ML) to learn and/or infer the user goal, activity, interest, preference, hobby, skill level, role, etc., information described above based on historical tracked usage information for the respective users regarding their historical usage of their CDs 136, and/or any relevant information about the respective users regarding their goals, interests, hobbies, skill level, etc., that may be provided at one or more network accessible data sources/systems (e.g., social medial systems 140, educational platforms, web-search content, online purchasing history data, etc.). For example, as described in greater detail infra with reference to FIG. 4 and machine learning component 404, in some embodiment the data collection component 106 can collect or otherwise receive tracked usage history data for a user and the user's CD that provides information regarding features, functionalities, applications, etc., of the device that are used, frequency of use, capacity of use and so on. Based on patterns in such tracked information, the machine learning component 304 can learn and forecast expected goals and needs of the user related to their future usage of the CD and potential equipment updates that are expected to facilitate the expected goals. Additional information provided by social media systems 140 such as frequency of posts, content of posts, number of contacts/followers, number of views, remarks/feedback on post content, and so on can also be factored into the machine learning analysis in association with forecasting user skill level, social media status, degree/level of association with a particular goal/hobby/group, and so on.

The clustering component 110 can define clustering operations for clustering users into different user groups for providing different targeted equipment updates tailored thereto (e.g., different updates for gamers verses content creators). In one or more embodiments, the clustering component 110 can cluster users (i.e., users respectively associated with the CDs 136) into different user groups based on different goals (or demands, needs, intentions) of the users using the goal information provided in their user profile data 120 (e.g., gaming, education, content creation, etc.). The result of these clustering operations can include the generation of different user groups with different goals/needs and/or expected goals/needs pertaining to their CD usage or future usage. The clustering component 110 can additionally, or alternatively, apply other criteria for clustering users into groups based on similar attributes pertaining to their goals or purposes for usage of their respective CDs 136, such as their activities, interests, preferences, hobbies, skill level, or role/title, and/or status (e.g., social medial status) and using the corresponding information as defined/provided in their user profile data 120. For example, the user group clusters could include one group of users who primarily use or intend to use their CD for gaming and another for education. In furtherance to this example, within the gaming group cluster there could be a sub-cluster of users consider amateur gamers and another considered professional gamers. The clustering component 118 can employ various suitable clustering algorithms such as k-means or the like to perform the user group clustering based on corresponding attribute data provided in the user profile data 120.

In some embodiments, the clustering component 110 can also cluster users into different user groups or subgroups based on their associated CDs. For example, the clustering component 110 can cluster users based on different types of hardware and/or software associated with their respective CDs 136 or groups of CDs. For instance, the users can be clustered into the same group or sub-group based on having a same or similar device usage goal and further having same or similar CD hardware and/or software.

The target updating component 112 can further determine or select appropriate equipment updates (e.g., software updates, hardware updates, etc.) tailored to the CDs associated with the different user groups, wherein in at least some embodiments, the user groups are based at least in part on their respective goals (or demands, needs, intentions). The equipment updates can include different equipment updates for different user groups and their corresponding CDs that are considered to facilitate the respective goals of the different user groups. For example, the target updating component 112 can determine or select a gaming related equipment update for the gaming group of users and a content creation related updated for the content creation group of users. In this regard, the specific equipment updates (e.g., software and/or hardware updates) that are selected for provisioning to the respective CDs 136 can be tailored to the usage goals and needs of their users.

In some implementations, the equipment updates can also be determined/selected based on compatibility with the respective hardware and/or software associated with the respective CDs of the users in the group. A compatible hardware update for a CD can refer to a hardware component (e.g., an auxiliary device/apparatus, a communication device accessory, etc.) adapted to compliment, enhance or change a functionality of the CD (or vice versa) when used in conjunction with the CD. A compatible software update for a CD can refer to a software component (e.g., firmware, an application, a program, an operating system change, etc.) adapted to compliment, enhance or change a functionality of the CD (or vice versa) when used in conjunction with the CD. Thus, the target updating component 112 can determine/selected targeted CD software and/or hardware updates for specific groups of CDs that are relevant to the hardware and/or software associated with the CDs and device usage goals (or intentions, needs, demands, etc.) associated with the users of the CDs.

In one or more embodiments, the update targeting component 112 can determine the appropriate equipment updates for different user groups and their respective goals, interests, activities, skill level, etc., using equipment update data 122. With these embodiments, the equipment updates data 122 can include information identifying or defining available equipment updates for different CDs, including software updates and hardware updates. The equipment update data 122 can further include information that relates the usefulness/appropriateness of respective equipment updates to facilitating, enabling or enhancing the different usage goals (or demands, needs, intentions, etc.), and/or activities, interests, skill levels, roles, and so on.

For example, the equipment update data 122 can include a list of all available software updates (e.g., firmware, applications, programs, operating system changes, etc.) and the types of CDs to which the respective software updates are applicable/compatible. The software updates can further be indexed as a function of attributes defining the relative usefulness/appropriateness of the respective software updates to facilitating the different usage goals and/or activities, interests, skill level, etc. (e.g., software update 1.1—facilitates amateur gaming, software update 1.2 facilitates advanced gaming, software update 2.1 is targeted for new content creators, software update 2.2 is targeted for advanced content creators, etc.). Additionally, or alternatively, the equipment update data 122 can include information that describes or defines the features and functionalities of the respective software updates, intended usages, ratings and so on. Similarly, the equipment update data 122 can include a list of all available hardware updates (e.g., auxiliary CDs, accessories, add-ons, etc.) and the types of CDs to which the respective hardware updates are applicable/compatible. The hardware updates can further be indexed as a function of attributes defining the relative usefulness/appropriateness of the respective hardware updates to facilitating the different usage goals and/or activities, interests, skill level, etc. (e.g., hardware update 1.1—facilitates amateur gaming, hardware update 1.2 facilitates advanced gaming, hardware update 2.1 is targeted for new content creators, hardware update 2.2 is targeted for advanced content creators, etc.). Additionally, or alternatively, the equipment update data 122 can include information that describes or defines the features and functionalities of the respective software updates, intended usages, ratings and so on.

Accordingly, in various embodiments, the update targeting component 112 can employ the equipment update data 122 to determine/select an appropriate equipment update for a particular user group based that provides features and functionalities tailored to the corresponding goals, interests, needs, skill level, activities, etc., associated with that respective user group. In association with determining/selecting an appropriate equipment update for a particular user group based on compatibility with the goals, interests, needs, etc., of the user group, the update targeting component 112 can also evaluate the CD information for the respective users to select/determine an equipment update that is compatible with their CD hardware/software (e.g., as provided in their user profile data 120).

Additionally, or alternatively, the update targeting component 112 can start with a particular equipment update tailored to a particular target goal, usage, functionality, etc. For example, the equipment update may include a new software update or hardware update that has become available to the system 100 and newly added to the equipment update data 122. Based on identification of the new equipment update, the target updating component 112 can further identify a group of users suited for the equipment update based on compatibility with their existing CDs (e.g., as appropriate depending on the type of update) and compatibility of the equipment update with the goals, needs, activities, skill level, etc., of the corresponding users, as determined based on their user profile data 120.

Still in other embodiments, the update targeting component 112 can determine one or more appropriate equipment updates for providing to some or all users/CDs included in a clustered user group based on analysis and comparison of the different hardware and software components associated with all the CDs associated with the group. For example, the update targeting component 112 can compare the different software and hardware components associated with the respective CDs of the users included in a group having a same or similar usage goal or other similar profile criteria related to their device usage activities, hobbies, interests, skill level, role, etc. to identify opportunities relative to the group where certain equipment updates would be appropriate to enhance or facilitate their goal in view of available equipment updates (e.g., defined in the equipment updates data 122). The update targeting component 112 can further identify certain hardware and/or software components for provisioning as equipment updates to a subset of users in the group based on exclusion of those components from their CDs and inclusion of those components in CDs of other users in the group. In this regard, the update targeting component 112 can perform a scan of the software and hardware components associated with CDs of a particular target user group and identify gaps or identify opportunities for enhancements among that group.

In some embodiments, in response to and/or based on selecting or determining an equipment update tailored to a particular user group (e.g., by the target updating component 112) the notification component 114 can notify corresponding users included in the group regarding the equipment update. For example, the notification component 114 can send equipment update notifications to respective CDs of the users in the group with information identifying the targeted equipment update available for the user and/or the user's CD. In some implementations of these embodiments, the notification can include a response prompt via which the user can respond to the notification accepting or rejecting the update. In some implementations, in response to acceptance of the update, the update provisioning component 116 can send or facilitate sending the equipment update to the user's CD (e.g., for software updates) and/or a physical address associated with the user (e.g., as provided in the user profile data, for hardware updates). Additionally, or alternatively, the update provisioning component 116 can be configured to send or facilitate sending equipment updates to CDs (e.g., for software updates) and/or a physical address associated with the users based on or in response to a determination or selection of the equipment update for a particular user group by target updating component 112 (e.g., equipment updates can be automatically provisioned to user groups without notifications).

In this regard, as applied to software updates, in some embodiments, the update provisioning component 116 can automatically send (e.g., push, transmit, etc.) software updates to one or more CDs 136 via the one or more communication networks 132. With these embodiments, the software updates can also be stored in the equipment update data 122 and/or at an external system, such as equipment provisioning system 138. In implementations in which the software updates are stored/provided by the equipment provisioning system 138, the update provisioning component 116 can interface with the equipment provisioning system and direct the equipment provisioning system to send the selected appropriate software updates to the respective CDs in a targeted user group. Similarly, as applied to hardware updates which include physical hardware components (e.g., devices, add-ons, accessories, etc.) that require shipping to physical addresses, the update provisioning component 116 can control/initiate sending the hardware updates to the physical addresses associated with users in association with interfacing with the equipment provisioning system 138. With these embodiments, the equipment provisioning system 138 can correspond to a CD hardware system that provides or controls the hardware update shipping and ordering process.

In some embodiments, the update provisioning component 116 can tailor the timing of provision (e.g., sending or directing the equipment provisioning system 138 to send) of equipment updates to CDs (for software updates) and/or user physical locations (for hardware updates) based on one or more contextual factors. In some implementations, the update provisioning component 116 can tailor the timing of provision of an equipment update to respective CDs included in a targeted user group based on a timing determined to be relevant to the group. The relevant timing can be based on context information associated with the group of users that indicates an appropriate timing for the equipment upgrade. For example, in some embodiments, the context information can identify an event associated with the group that pertains to the goal associated with user group for which the equipment update was targeted. For example, a gaming event (e.g., a gaming contest), an education event (e.g., the first day of school), a work event, (e.g., a work conference), a social event (e.g., a concert, a sports game, etc.). With these embodiments, the update provisioning component 116 can schedule timing of provision of the equipment update (e.g., provision of a push software update and/or delivery of a physical hardware update) based on the timing of the relevant event associated with the targeted group (e.g., to provide a gaming related equipment update at or near the timing of the gaming event, and so on). The update provisioning component 116 can also control timing of provision or sending of software updates to CDs as a function of user group need, network conditions (e.g., push updates at times/periods of low network load/congestion), CD battery levels, and other factors.

In some embodiments, the event information may also be used by the user profiling component 108 (e.g., and/or the machine learning component 304 as discussed infra) to determine or infer user goal information, and/or the clustering component 110 to cluster users into user group based on association with the event. For example, the user profiling component 108 and/or the clustering component 110 can receive (e.g., via the data collection component 106) information indicating timing of occurrence of different types of events associated with different user goals and interests (e.g., gaming events, school events, social events, etc.) and information identifying or indicating users registered to attend such events. In various embodiments, this type of information can be collected by the data collection component 106 in association with crawling and monitoring user activity and CD usage at various other network accessible systems/data sources 142.

In some implementations, the clustering component 110 can generate a user group corresponding to users associated with a particular event (e.g., a gaming event, an education event, a travel event, etc.) and associate an activity or purpose of the event as a CD usage goal or need associated with the group (e.g., a group consisting of gamers participating in an advanced gaming event, wherein the goal corresponds to an advance gaming goal). The target updating component 112 can further determine/select a targeted equipment update for this group of users tailored to the associated activity or purpose of the event (e.g., advanced gaming), and the update provisioning component 116 can provide the targeted update to respective CDs devices associated with the group (e.g., a software update and/or a hardware update) at or near a timing of the event. In this regard, the system 100 can provide highly targeted software and/or hardware updates for CDs based goals and activities of their users related to their usage of the CDs and contextual events related to such goals and activities.

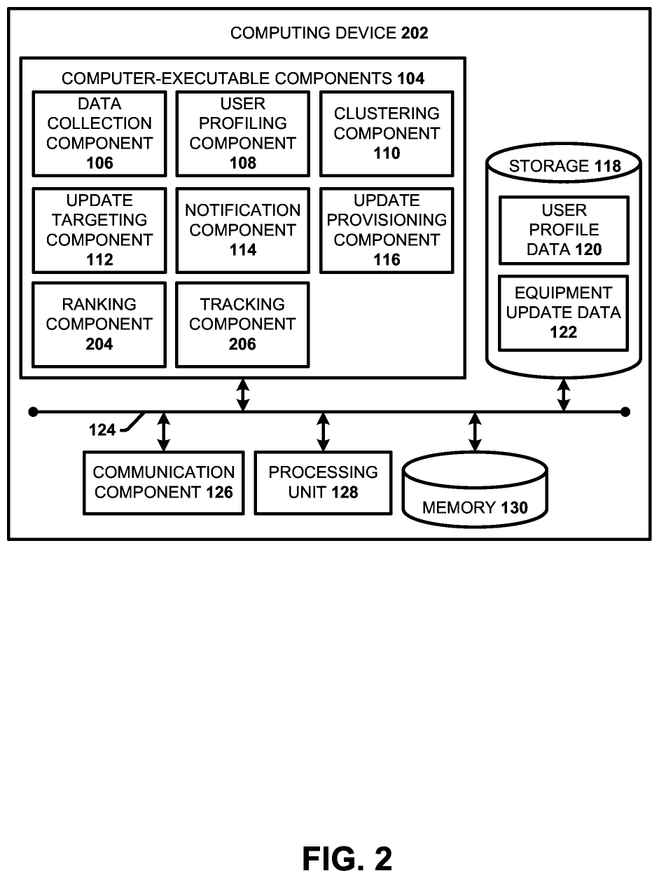

FIG. 2 illustrates an example, non-limiting computing device 202 that facilitates providing targeted software and hardware updates for UE based on specific user profiles related to their usage thereof, in accordance with one or more embodiments of the disclosed subject matter. Computing device 202 is similar to computing device 102 of system 100 with the addition of ranking component 204 and tracking component 206. In various embodiments, computing device 202 can replace computing device 102 of system 100. Repetitive description of like elements employed in respective embodiments is omitted for sake of brevity.

In one or more embodiments, the ranking component 204 can determine a hierarchical ranking of respective users included in the clustered user group determined by the clustering component 110. With these embodiments, the update provisioning component 116 can facilitate providing (e.g., sending, pushing, or otherwise providing) equipment updates to respective users of the group and/or their corresponding CDs (e.g., with respect to software updates) in an order determined according to the hierarchical ranking (e.g., providing higher ranked user updates before lower ranked users).

The ranking component 204 can determine the hierarchical ranking of users included in a user group based on one or more ranking criteria. In some implementation, the ranking criteria can include a respective status of the users included in the group that relates to the particular device usage goal for which the group is based. For example, the assuming the goal pertains to an activity such as gaming, the status can be based on gaming status in the gaming community and/or a particular type of game that relates to their level of skill, performance ability (e.g., scores, performance rating, etc.), sponsorship, popularity, and similar criteria. For example, users with a higher skill level or expertise in a particular goal-based device need can be ranked higher than users with a lower skill level. Similar criteria corresponding to a degree of level of skill with respect to the goal related activity can also be used to rank users associated with other goals/activities such as content creation, education, photography, videography, programming, and various other activities. In other implementations, the status can pertain to a social media status, wherein higher ranked users can correspond to those with an “influencer” status, those user with a greater number of social media connections (e.g., friends, followers, media attention, and so on.) In some implementations, users included amongst a group classified as influencers can receive equipment updates before other users included in the group with lower social media influence. Such influencers or any higher ranked user in a group for that matter can serve as alpha/beta testers of new equipment updates before sending to the rest of the group. The subset of higher ranked/influencer users may also be provided with incentives to promote, rate and review the new equipment updates on social media in exchange for discounted updates or other reward offers (e.g., free updates, reduced rate plan charges, etc.).

In other embodiments, the ranking criterion can include relative priority of the usage goal to respective users included in the group. For example, in some embodiments, a clustered user group can include users with user profile data 120 that indicate they have a particular goal (or demand, need, intent) with respect to usage of their CD, however the goal may be a primary goal, a secondary goal, a tertiary goal and so one. With these embodiments, users with profile data 120 indicating the goal as a primary goal can be ranked higher relative users indicating the goal is a secondary goal and so on.

Other criteria that can be used to rank respective users included in a same user group can include but are not limited to: SLA agreement priority parameters (e.g., users with higher rate and/or higher priority subscription plans or service agreements can be ranked higher than users with lower rate and/or lower priority subscription plans), relative level of urgency or need for the equipment update, CD capabilities, current CD battery levels (e.g., users with CDs having higher battery levels can be ranked higher for pushing battery consuming software updates before other users with less battery power available), and CD location and corresponding serving network node load, and costs (e.g., providing updates to users/CDs attributed with greater return costs/profits relative users with lower return costs/profits).

The tracking component 206 can further regularly and/or continuously track users over time to learn and determine updates to their user profile information pertaining to their goals, interests, needs and CD device usage. For example, the tracking component 206 can intelligently (e.g., using AI and/or ML) track users CD device usage activity, social media activity and other information related to their device usage to determine changes in status (e.g., from basic gamer to professional gamer, from basic photography to advanced photographer, etc.), changes in goals, changes in their interests and hobbies and so on. In this regard, the tracking component 206 can generate and track historical usage information for the respective users having profiles in the user profile data 120 related to historical usage of their user equipment. The tracked information can also comprise registration information regarding registration of the user for events (e.g., gaming events, social events, concerts, conferences, flights/travel, education events), participation in the events, device usage associated with the events, social media activity, online gaming and various other types of information pertaining to the respective users interests and activities relating to their CD device usage. In some implementations, the tracked information can include device hardware and software features used and not used, and frequency of use. The update provisioning component 116 can further determine new equipment updates for users based on changes in their profile information over time. In this regard, the update provisioning component 116 can be aware of the users' profile data and changes in their profile data and constantly/regularly identify and suggest new targeted equipment updates tailored to their profile data to enhance their experience over time (e.g., for gamers—suggesting device/software updates to enhance gaming experience).

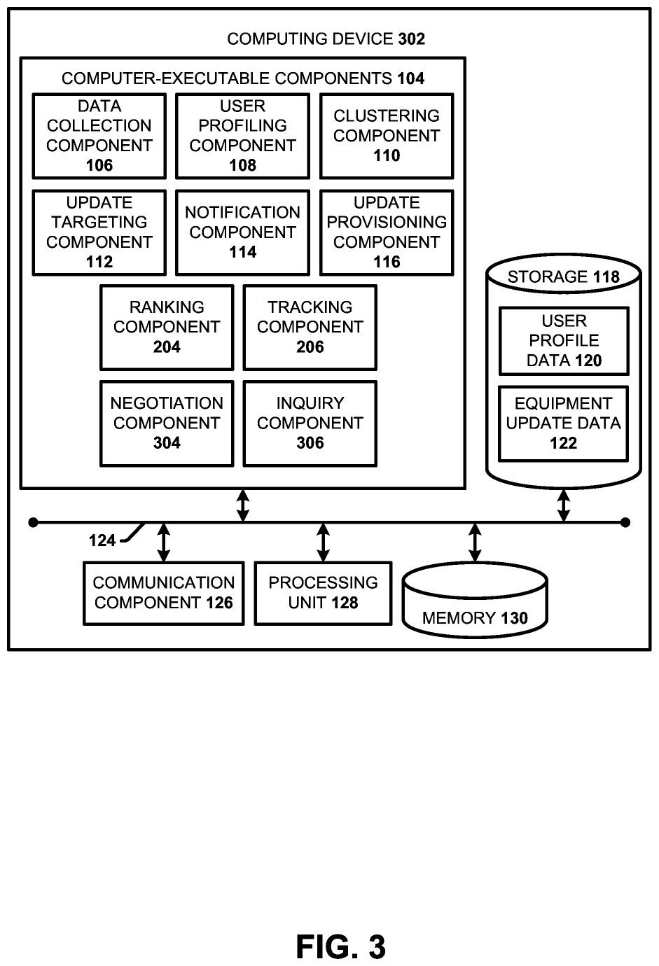

FIG. 3 illustrates another example, non-limiting computing device 302 that facilitates providing targeted software and hardware updates for UE based on specific user profiles related to their usage thereof, in accordance with one or more embodiments of the disclosed subject matter. Computing device 302 is similar to computing device 202 with the addition of negotiation component 304 and inquiry component 306. In various embodiments, computing device 302 can replace computing device 102 of system 100. Repetitive description of like elements employed in respective embodiments is omitted for sake of brevity.

The negotiation component 304 can facilitate negotiation of targeted updates between the respective users of the CDs 136 and the update provisioning component 116. For example, in some embodiments, the negotiation component 304 can provide a negotiation mechanism that whereby users can request user equipment updates. For example, the negotiation component 304 can receive user requests for specific equipment updates identified by a unique update identification name/number, and/or for general updates related to a particular device usage goal (or demand, need, intent), user interest, user preference, and so one. The negotiation component 304 can further negotiate timing of provision of the updates to the users/users' CDs based on the requests, as well as costs associated with the updates (e.g., payment, increase in rate plan, or another form of provider reimbursement such as posting/advertising about the update on social media). The update provisioning component 116 can further provide the users/users CD with the updates accordingly (e.g., at the negotiated time/rate) upon complement of the update negotiation parameters. In some embodiments, the negotiation component 304 can further “veto” or “vote up” certain updates/update requests.

In some embodiments, the negotiation component 304 can initiate an update negotiation process with all (or subset) of users included in a clustered user group (e.g., generated by the clustering component 110) to negotiate provision of a particular equipment update for the group. For instance, based on selection/determination of an appropriate equipment update for a particular user group by the update targeting component 112, the negotiation component 304 can initiate a negation process with the entire group (or a subset thereof) to negotiate a rate/cost for provision of the update to the group and/or a timing of provision of the update for the group. In some implementations of these embodiments, the notification component 114 can send an update notification to the group (e.g., to respective CDs of the group) identifying the equipment update that has been determined suitable for that group with a prompt allowing or enabling the users to respond to the notification with information indicating whether they would be interested in receiving the update. The negotiation component 304 can further negotiate a reduced rate/reimbursement plan for provision of the update to the group based on the number of users in the group that participate in receiving the update. In some embodiments, the negotiation component 114 can further request volunteers from the group to participate, and/or provide incentives (e.g., reduced rates, free updates/upgrades or other incentives) for the first N number of users that volunteer and/or accept the update and/or volunteer to test out the equipment update.

In some embodiments, the inquiry component 306 can directly inquire/solicit users to determine their profile data pertaining to goals and updates that they may be interested in to gain an understanding of what updates were be most beneficial to certain user groups. The inquiry component 306 can further solicit an understanding of user hierarchy or ranking between users in a group who have a similar need/goal. For example, based on clustering of users into a particular user group (e.g., gaming), the inquiry component 306 can solicit the users in the group to provide additional information regarding their status/skill level associated with the goal/activity for which the group is based, their future interest level in goal/activity, and other pertinent information that can be used to rank respective users in the group into a hierarchy for providing equipment updates related to the group.

In some embodiments, the inquiry component 306 can perform a user group inquiry procedure to facilitate determining appropriate updates for a user group determined by the clustering component 110. For example, in response to and/or based on generation of a user group associated with a particular CD usage goal, user interest, user demand, user status, user skill level and so on, the inquiry component 306 can direct the notification component 114 to notify respective users (e.g., via their respective CDs) that they have been identified as being associated with a relevant target user group. The inquiry component 306 can further perform an equipment update process with the respective users requesting them to provide feedback regarding potential equipment updates they might be interested in. For example, the inquiry component 306 can provide the users with information identifying candidate equipment updates determined to be relevant or potentially relevant to the group and their respective CDs and ask the users to rate the respective equipment updates in terms of preference and/or need. The inquiry component 306 can further provide the received user feedback to the update provisioning component 116 to facilitate determining/selecting the best equipment update or updates to provide to the group. In this regard, the negotiation component 304 and the inquiry component 306 can vet, prioritize and negotiate with different user groups regarding provisioning of equipment updates.

FIG. 4 illustrates another example, non-limiting computing device 402 that facilitates providing targeted software and hardware updates for UE based on specific user profiles related to their usage thereof, in accordance with one or more embodiments of the disclosed subject matter. Computing device 402 is similar to computing device 302 of with the addition of machine learning component 404. In various embodiments, computing device 402 can replace computing device 102 of system 100. Repetitive description of like elements employed in respective embodiments is omitted for sake of brevity.

The machine learning component 404 can employ one or more machine learning techniques to learn and define user profile data 120, the equipment update data 122, user hierarchy rankings, and/or the targeted equipment updates for recommending and/or provisioning to different user groups, a based on learned patterns, correlations and/or rules between the variety of information the system 100 has access too as discussed herein. Additionally, or alternatively, the machine learning component 404 can train and develop one or more machine learning models to automatically infer information regarding user equipment usage demands, goals and needs based on the learned patterns, correlations and/or rules.

To facilitate this end, the machine learning component 404 can perform learning with respect to any and all of the data received by computing device 102, computing device 202, and computing device 302. Hereinafter, any information received by any of these computing devices and/or generated by any of these computing devices computing device can be aggregated over time and used as machine learning data. Hereinafter, this information is collectively referred to as “machine learning data.”

It should be appreciated that machine learning component 404 can perform learning associated with the machine learning data explicitly or implicitly. Learning and/or determining inferences by the machine learning component 404 can facilitate identification and/or classification of different patterns associated with the machine learning data, determining one or more rules associated with the machine learning data, and/or determining one or more relationships associated with the machine learning data that can influence learning the user profile data 120 and matching the user profile data 120 to targeted equipment updates defined in the equipment update data 122. The machine learning component 404 can also employ an automatic classification system and/or an automatic classification process to facilitate identification and/or classification of different patterns associated with the machine learning data, determining one or more rules associated with the machine learning data, and/or determining one or more relationships associated with the machine learning data that can influence learning the user profile data 120 and matching the user profile data 120 to targeted equipment updates defined in the equipment update data 122.

For example, the machine learning component 404 can employ a probabilistic and/or statistical-based analysis (e.g., factoring into the analysis utilities and costs) to learn one or more patterns associated with the machine learning data, determining one or more rules associated with the machine learning data, and/or determining one or more relationships associated with the machine learning data that can influence learning the user profile data 120 and matching the user profile data 120 to targeted equipment updates defined in the equipment update data 122. The machine learning component 404 can employ, for example, a support vector machine (SVM) classifier to facilitate learning patterns associated with the machine learning data, determining one or more rules associated with the machine learning data, and/or determining one or more relationships associated with the machine learning data that can influence learning the user profile data 120 and matching the user profile data 120 to targeted equipment updates defined in the equipment update data 122. Additionally, or alternatively, the machine learning component 404 an employ other classification techniques associated with Bayesian networks, decision trees and/or probabilistic classification models. Classifiers employed by the machine learning component 404 can be explicitly trained (e.g., via a generic training data) as well as implicitly trained (e.g., via observing user behavior, receiving extrinsic information). For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence (class).

In an aspect, the machine learning component 404 can utilize in part inference-based schemes to facilitate learning one or more patterns associated with the machine learning data, determining one or more rules associated with the machine learning data, and/or determining one or more relationships associated with the machine learning data that can influence learning the user profile data 120 and matching the user profile data 120 to targeted equipment updates defined in the equipment update data 122. The machine learning component 404 can further employ any suitable machine-learning based techniques, statistical-based techniques and/or probabilistic-based techniques. The machine learning component 404 can additionally or alternatively employ a reduced set of factors (e.g., an optimized set of factors) to facilitate generating one or more machine learning models that facilitate learning the user profile data 120 and matching the user profile data 120 to targeted equipment updates defined in the equipment update data 122. For example, the machine learning component 404 can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, etc. In another aspect, the machine learning component 404 can perform a set of machine learning computations associated with the machine learning data. For example, the machine learning component 404 can perform a set of clustering machine learning computations, a set of decision tree machine learning computations, a set of instance-based machine learning computations, a set of regression machine learning computations, a set of regularization machine learning computations, a set of rule learning machine learning computations, a set of Bayesian machine learning computations, a set of deep Boltzmann machine computations, a set of deep belief network computations, a set of convolution neural network computations, a set of stacked auto-encoder computations and/or a set of different machine learning computations. Any rules, patterns, and/or correlations learned by the machine learning component 404 with respect to the machine learning data can further be stored in the storage 118 and/or memory 130 and applied by the machine learning component 404 to define, and/or update/refine the user profile data 120, the equipment update data 122 and/or facilitate matching the user profile data 120 to targeted equipment updates defined in the equipment update data 122.

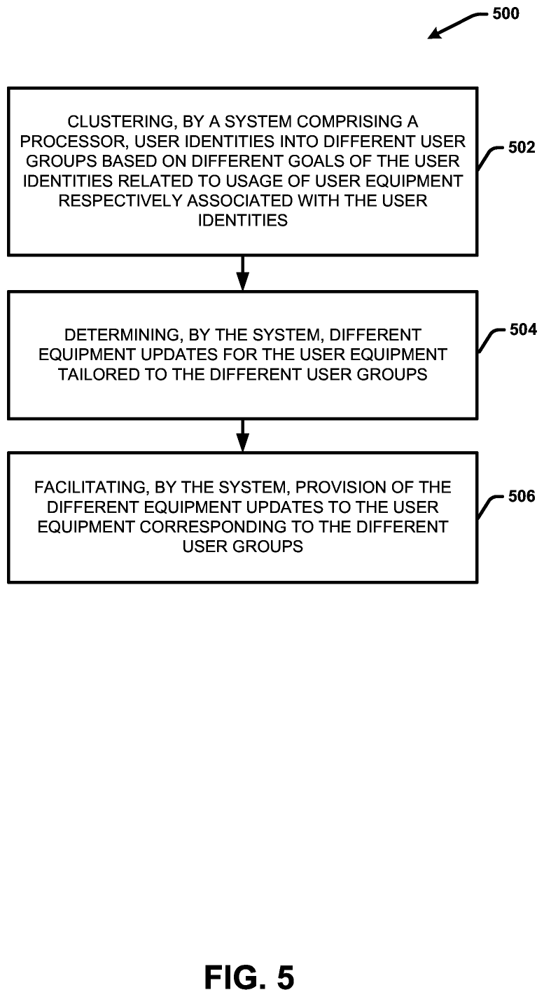

FIG. 5 illustrates a block diagram of an example, non-limiting computer implemented method 500 for providing targeted software and hardware updates for UE based on specific user profiles related to their usage thereof, in accordance with one or more embodiments of the disclosed subject matter. Repetitive description of like elements employed in respective embodiments is omitted for sake of brevity.

At 502, a system comprising a processor (e.g., system 100) can cluster (e.g., via clustering component 110) user identities (e.g., users of CDs 136) into different user groups based on different goals of the user identities related to usage of user equipment (e.g., CDs 136) respectively associated with the user identities. At 504, the system can determine different equipment updates for the user equipment tailored to the different user groups (e.g., via update targeting component 112). In this regard, the particular equipment updates determined selected for each of the different user groups can vary and be tailored to the device usage demands, goals, needs, etc., associated with the different user groups. At 506, the system can further facilitate provisioning of the different equipment updates to the user equipment corresponding to the different user groups (e.g., via update provisioning component 116).

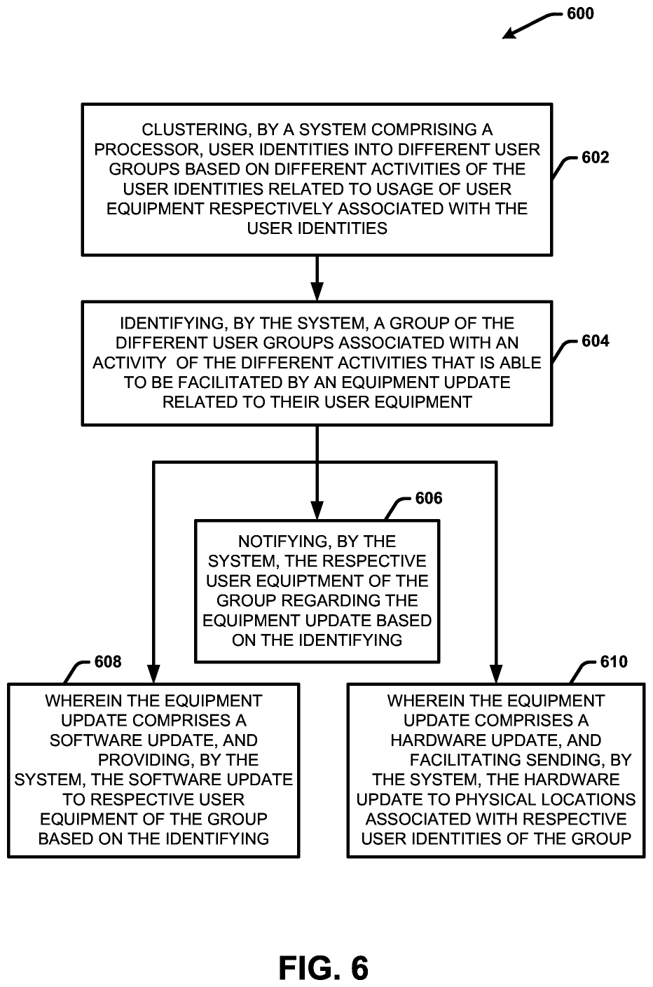

FIG. 6 illustrates a block diagram of another example, non-limiting computer implemented method 600 for providing targeted software and hardware updates for UE based on specific user profiles related to their usage thereof, in accordance with one or more embodiments of the disclosed subject matter. Repetitive description of like elements employed in respective embodiments is omitted for sake of brevity.

At 602, a system comprising a processor (e.g., system 100) can cluster (e.g., via clustering component 110) user identities (e.g., users of CDs 136) into different user groups based on different activities (e.g., gaming, advanced gaming, education, participation in a particular type of upcoming event involving using of their CD, etc.) of the user identities related to usage of user equipment (e.g., CDs 136) respectively associated with the user identities. At 604, the system can identify group of the different user groups associated with an activity that is able to be facilitated by an equipment update related to their user equipment (e.g., via update targeting component 112). For example, the update targeting component 604 can identify a particular new equipment update that has become available for provisioning to the users as defined in the equipment update data 122 that is associated with information indicating that the new equipment update is particular useful or relevant to the activity (e.g., gaming, advanced gaming, education, participation in the particular type of upcoming event involving using of their CD, etc.). Based on and/or responsive to identifying the group, the system can further notify the respective user equipment of the group regarding the equipment update at 606. Additionally, or alternatively, if the equipment update comprises a software update, at 608, the system can provide (e.g., via the update provisioning component 116 and/or the equipment provisioning system 138) the software update to respective user equipment of the group based on and/or responsive to the identifying. Additionally, or alternatively, if the equipment update comprises a hardware update, at 610, the system can facilitate sending (e.g., via the update provisioning component 116 and/or the equipment provisioning system 138) the hardware update to physical locations associated with respective user identities in the group based on and/or responsive to the identifying.

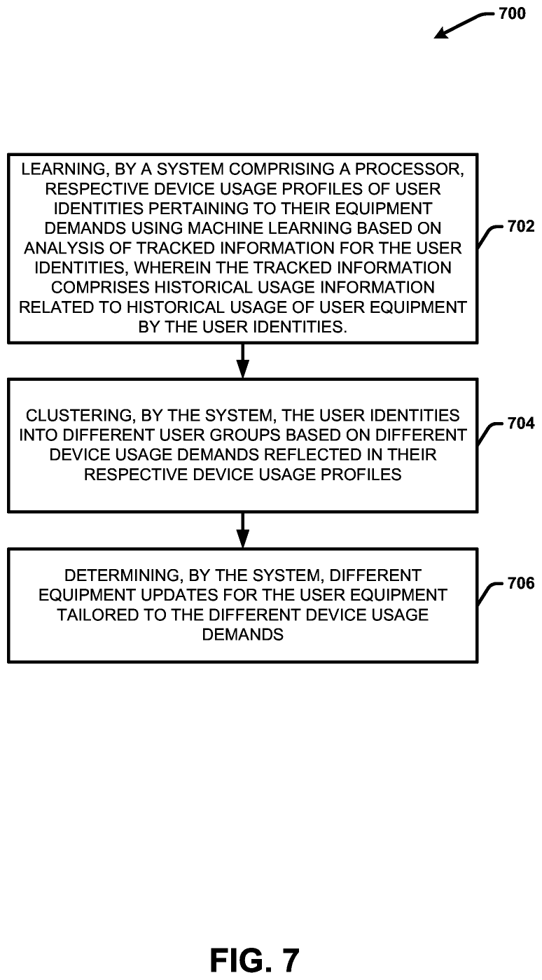

FIG. 7 illustrates a block diagram of another example, non-limiting computer implemented method 700 for providing targeted software and hardware updates for UE based on specific user profiles related to their usage thereof, in accordance with one or more embodiments of the disclosed subject matter. Repetitive description of like elements employed in respective embodiments is omitted for sake of brevity.

At 702, a system comprising a processor (e.g., system 100) can learn (e.g., via machine learning component 404), respective device usage profiles of user identities pertaining to their equipment demands using machine learning based on analysis of tracked information for the user identities, wherein the tracked information comprises historical usage information related to historical usage of user equipment (e.g., CDs 136) by the user identities. At 704, the system can cluster (e.g., via clustering component 110) the user identities (e.g., users of CDs 136) into different user groups based on different device usage demands of the user identities reflected in their respective device usage profiles. At 706, the system can different equipment updates for the user equipment tailored to the different device usage demands (e.g., via update targeting component 112).

One or more embodiments can be a system, a method, and/or a computer program product at any possible technical detail level of integration. The computer program product can include a computer readable storage medium (or media) having computer readable program instructions thereon for causing a processor to carry out one or more aspects of the present embodiments.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, procedural programming languages, such as the “C” programming language or similar programming languages, and machine-learning programming languages such as like CUDA, Python, Tensorflow, PyTorch, and the like. The computer readable program instructions can execute entirely on the user's computer, partly on the user's computer, as a stand-alone software package, partly on the user's computer and partly on a remote computer or entirely on the remote computer or server using suitable processing hardware. In the latter scenario, the remote computer can be connected to the user's computer through any type of network, including a local area network (LAN) or a wide area network (WAN), or the connection can be made to an external computer (for example, through the Internet using an Internet Service Provider). In various embodiments involving machine-learning programming instructions, the processing hardware can include one or more graphics processing units (GPUs), central processing units (CPUs), and the like. In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In order to provide additional context for various embodiments described herein, FIG. 8 and the following discussion are intended to provide a brief, general description of a suitable computing environment 800 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 8, the example environment 800 for implementing various embodiments of the aspects described herein includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures can also be employed as the processing unit 804.

The system bus 808 can be any of several types of bus structure that can further interconnect to a memory bus (with or without a memory controller), a peripheral bus, and a local bus using any of a variety of commercially available bus architectures. The system memory 806 includes ROM 810 and RAM 812. A basic input/output system (BIOS) can be stored in a non-volatile memory such as ROM, erasable programmable read only memory (EPROM), EEPROM, which BIOS contains the basic routines that help to transfer information between elements within the computer 802, such as during startup. The RAM 812 can also include a high-speed RAM such as static RAM for caching data.

The computer 802 further includes an internal hard disk drive (HDD) 814 (e.g., EIDE, SATA), one or more external storage devices 816 (e.g., a magnetic floppy disk drive (FDD) 816, a memory stick or flash drive reader, a memory card reader, etc.) and a drive 820, e.g., such as a solid state drive, an optical disk drive, which can read or write from a disk 822, such as a CD-ROM disc, a DVD, a BD, etc. Alternatively, where a solid state drive is involved, disk 822 would not be included, unless separate. While the internal HDD 814 is illustrated as located within the computer 802, the internal HDD 814 can also be configured for external use in a suitable chassis (not shown). Additionally, while not shown in environment 800, a solid state drive (SSD) could be used in addition to, or in place of, an HDD 814. The HDD 814, external storage device(s) 816 and drive 820 can be connected to the system bus 808 by an HDD interface 824, an external storage interface 826 and a drive interface 828, respectively. The interface 824 for external drive implementations can include at least one or both of Universal Serial Bus (USB) and Institute of Electrical and Electronics Engineers (IEEE) 1384 interface technologies. Other external drive connection technologies are within contemplation of the embodiments described herein.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 812, including an operating system 830, one or more application programs 832, other program modules 834 and program data 836. All or portions of the operating system, applications, modules, and/or data can also be cached in the RAM 812. The systems and methods described herein can be implemented utilizing various commercially available operating systems or combinations of operating systems.

Computer 802 can optionally comprise emulation technologies. For example, a hypervisor (not shown) or other intermediary can emulate a hardware environment for operating system 830, and the emulated hardware can optionally be different from the hardware illustrated in FIG. 8. In such an embodiment, operating system 830 can comprise one virtual machine (VM) of multiple VMs hosted at computer 802. Furthermore, operating system 830 can provide runtime environments, such as the Java runtime environment or the .NET framework, for applications 832. Runtime environments are consistent execution environments that allow applications 832 to run on any operating system that includes the runtime environment. Similarly, operating system 830 can support containers, and applications 832 can be in the form of containers, which are lightweight, standalone, executable packages of software that include, e.g., code, runtime, system tools, system libraries and settings for an application.

Further, computer 802 can be enable with a security module, such as a trusted processing module (TPM). For instance with a TPM, boot components hash next in time boot components, and wait for a match of results to secured values, before loading a next boot component. This process can take place at any layer in the code execution stack of computer 802, e.g., applied at the application execution level or at the operating system (OS) kernel level, thereby enabling security at any level of code execution.

A user can enter commands and information into the computer 802 through one or more wired/wireless input devices, e.g., a keyboard 838, a touch screen 840, and a pointing device, such as a mouse 842. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 804 through an input device interface 844 that can be coupled to the system bus 808, but can be connected by other interfaces, such as a parallel port, an IEEE 1384 serial port, a game port, a USB port, an IR interface, a BLUETOOTH® interface, etc.

A monitor 846 or other type of display device can be also connected to the system bus 808 via an interface, such as a video adapter 848. In addition to the monitor 846, a computer typically includes other peripheral output devices (not shown), such as speakers, printers, etc.

The computer 802 can operate in a networked environment using logical connections via wired and/or wireless communications to one or more remote computers, such as a remote computer(s) 850. The remote computer(s) 850 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 852 is illustrated. The logical connections depicted include wired/wireless connectivity to a local area network (LAN) 854 and/or larger networks, e.g., a wide area network (WAN) 856. Such LAN and WAN networking environments are commonplace in offices and companies, and facilitate enterprise-wide computer networks, such as intranets, all of which can connect to a global communications network, e.g., the Internet.

When used in a LAN networking environment, the computer 802 can be connected to the local network 854 through a wired and/or wireless communication network interface or adapter 858. The adapter 858 can facilitate wired or wireless communication to the LAN 854, which can also include a wireless access point (AP) disposed thereon for communicating with the adapter 858 in a wireless mode.

When used in a WAN networking environment, the computer 802 can include a modem 860 or can be connected to a communications server on the WAN 856 via other means for establishing communications over the WAN 856, such as by way of the Internet. The modem 860, which can be internal or external and a wired or wireless device, can be connected to the system bus 808 via the input device interface 844. In a networked environment, program modules depicted relative to the computer 802 or portions thereof, can be stored in the remote memory/storage device 852. It will be appreciated that the network connections shown are example and other means of establishing a communications link between the computers can be used.

When used in either a LAN or WAN networking environment, the computer 802 can access cloud storage systems or other network-based storage systems in addition to, or in place of, external storage devices 816 as described above, such as but not limited to a network virtual machine providing one or more aspects of storage or processing of information. Generally, a connection between the computer 802 and a cloud storage system can be established over a LAN 854 or WAN 856 e.g., by the adapter 858 or modem 860, respectively. Upon connecting the computer 802 to an associated cloud storage system, the external storage interface 826 can, with the aid of the adapter 858 and/or modem 860, manage storage provided by the cloud storage system as it would other types of external storage. For instance, the external storage interface 826 can be configured to provide access to cloud storage sources as if those sources were physically connected to the computer 802.

The computer 802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The illustrated aspects of the disclosure may also be practiced in distributed computing environments where certain tasks are performed by remote processing devices that are linked through a communications network. In a distributed computing environment, program modules can be located in both local and remote memory storage devices.

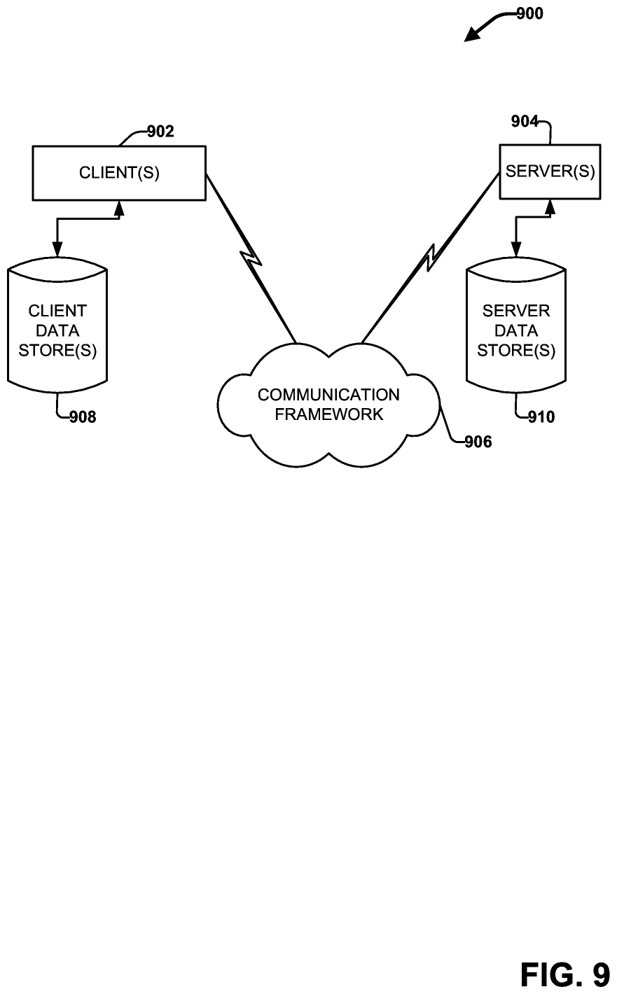

Referring to FIG. 9, there is illustrated a schematic block diagram of a computing environment 900 in accordance with this disclosure in which the subject systems (e.g., system 100), methods and computer readable media can be deployed. The computing environment 900 includes one or more client(s) 902 (e.g., laptops, smart phones, PDAs, media players, computers, portable electronic devices, wearable devices, tablets, and the like). The client(s) 902 can be hardware and/or software (e.g., threads, processes, computing devices). The computing environment 900 also includes one or more server(s) 904. The server(s) 904 can also be hardware or hardware in combination with software (e.g., threads, processes, computing devices). The servers 904 can house threads to perform transformations by employing aspects of this disclosure, for example. In various embodiments, one or more components, devices, systems, or subsystems of system 100 can be deployed as hardware and/or software at a client 902 and/or as hardware and/or software deployed at a server 904. One possible communication between a client 902 and a server 904 can be in the form of a data packet transmitted between two or more computer processes wherein the data packet may include healthcare related data, training data, AI models, input data for the AI models, encrypted output data generated by the AI models, and the like. The data packet can include a metadata, e.g., associated contextual information, for example. The computing environment 900 includes a communication framework 906 (e.g., a global communication network such as the Internet, or mobile network(s)) that can be employed to facilitate communications between the client(s) 1002 and the server(s) 904.

Communications can be facilitated via a wired (including optical fiber) and/or wireless technology. The client(s) 902 include or are operatively connected to one or more client data store(s) 908 that can be employed to store information local to the client(s) 902. Similarly, the server(s) 904 are operatively include or are operatively connected to one or more server data store(s) 910 that can be employed to store information local to the servers 1004.

In one embodiment, a client 902 can transfer an encoded file, in accordance with the disclosed subject matter, to server 904. Server 904 can store the file, decode the file, or transmit the file to another client 902. It is to be appreciated, that a client 902 can also transfer uncompressed file to a server 904 can compress the file in accordance with the disclosed subject matter. Likewise, server 904 can encode video information and transmit the information via communication framework 906 to one or more clients 902.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “subsystem” “platform,” “layer,” “gateway,” “interface,” “service,” “application,” “device,” and the like, can refer to and/or can include one or more computer-related entities or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of entity equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations can be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor; and
a memory that stores executable instructions that, when executed by the processor, facilitate performance of operations, comprising:
clustering user identities into different user groups based on different goals determined to be applicable to the user identities related to usage of user equipment respectively associated with the user identities;
determining different equipment updates for the user equipment tailored to the different user groups; and
provisioning the different equipment updates to the user equipment corresponding to the different user groups.

2. The system of claim 1, wherein the different equipment updates comprise different software updates, and wherein the provisioning comprises sending the different software updates to the user equipment corresponding to the different groups.

3. The system of claim 1, wherein the different equipment updates comprise different hardware updates, and wherein the provisioning comprises sending the different hardware updates to respective physical locations associated with the user identities corresponding to the different groups.

4. The system of claim 1, wherein the operations further comprise:
identifying a group of the different user groups associated with a goal of the different goals that is able to be facilitated by an equipment update related to respective user equipment of the group; and
notifying the respective user equipment of the group regarding the equipment update based on the identifying, wherein the notifying comprises sending, to the respective user equipment of the group, notification information regarding the equipment update.

5. The system of claim 4, wherein the equipment update comprises a software update, and wherein the operations further comprise:
sending the software update to the respective user equipment based on the identifying.

6. The system of claim 5, wherein the sending comprises sending the software update at a time determined to be relevant to the group.

7. The system of claim 5, wherein the sending comprises sending the software update to the respective user equipment in an order determined according to a hierarchical ranking of respective user identities included in the group.

8. The system of claim 7, wherein the operations further comprise:
determining the hierarchical ranking based on a status of the respective user identities included in the group.

9. The system of claim 1, wherein the operations further comprise:
learning the different goals of the user identities using machine learning based on analysis of tracked information for the user identities, wherein the tracked information comprises historical usage information related to historical usage of the user equipment by the user identities.

10. The system of claim 9, wherein the tracked information further comprises registration information regarding registration of the user identities for events.

11. The system of claim 1, wherein the clustering is further based on an additional criterion selected from the group consisting of: social media status, user interests, and user activities.

12. A method, comprising:
clustering, by a system comprising a processor, user identities into different user groups based on different demands of the user identities related to usage of user equipment respectively associated with the user identities;
determining, by the system, different equipment updates for the user equipment tailored to the different user groups; and
facilitating, by the system, provisioning of the different equipment updates to the user equipment corresponding to the different user groups.

13. The method of claim 12, wherein the different equipment updates comprise different software updates, and wherein the facilitating comprises sending the different software updates to the user equipment corresponding to the different groups.

14. The method of claim 12, wherein the different equipment updates comprise different hardware updates, and wherein the facilitating comprises sending the different hardware updates to respective physical locations associated with the user identities corresponding to the different groups.

15. The method of claim 12, further comprising:
identifying, by the system, a group of the different user groups associated with a demand of the different demands that is able to be facilitated by an equipment update related to respective user equipment of the group; and
notifying the respective user equipment of the group regarding the equipment update based on the identifying, wherein the notifying comprises sending, to the respective user equipment of the group, notification information regarding the equipment update.

16. The method of claim 15, wherein the equipment update comprises a software update, and wherein the operations further comprise:
sending the software update to the respective user equipment based on the identifying.

17. The method of claim 16, wherein the sending comprises sending the software update at a time determined to be relevant to the group.

18. The system of claim 16, further comprising:
determining, by the system, a hierarchical ranking of respective user identities included in the group based on a status of the respective user identities, and wherein the sending comprises sending the software update to the respective user equipment in an order determined according to the hierarchical ranking.

19. A non-transitory machine-readable medium, comprising executable instructions that, when executed by a processor, facilitate performance of operations, comprising:
clustering user identities into different user groups based on different profiles of the user identities related to usage of user equipment respectively associated with the user identities;
determining different equipment updates for the user equipment tailored to the different user groups; and
initiating provisioning of the different equipment updates to the user equipment corresponding to the different user groups.

20. The non-transitory machine-readable medium of claim 19, wherein the different equipment updates comprise different software updates, and wherein the initiating comprises sending the different software updates to the user equipment corresponding to the different groups.
